(19) United States
(12) Patent Application Publication
(10) Pub. No.: US 2024/0095854 A1
(43) Pub. Date: Mar. 21, 2024

(54) VIRTUAL AGENT FOR PROPERTY INCIDENT REMEDIATION

(71) Applicant: AT&T Intellectual Property I, L.P., Atlanta, GA (US)

(72) Inventors: Adrianne Luu, Atlanta, GA (US); Robert Moton, JR., Alpharetta, GA (US); Ryan Schaub, Berkeley Lake, GA (US); Timothy Knezevich, Mentor, OH (US); Barrett Kreiner, Woodstock, GA (US); Wei Wang, Harrison, NJ (US); Ari Craine, Marietta, GA (US); Robert Koch, Peachtree Corners, GA (US)

(21) Appl. No.: 17/933,700

(22) Filed: Sep. 20, 2022

(51) Int. Cl. G06Q 50/16; G06Q 10/10

(52) U.S. Cl. CPC G06Q 50/163; G06Q 10/1095; G08B 21/20

(57) ABSTRACT

The disclosed technology is directed towards enabling a property, such as via a device associated with a residential or commercial property, to identify an issue and arrange for mediation of the issue. For example, a service provider can be automatically scheduled to resolve a maintenance issue at a scheduled time, with controlled (e.g., key code-based) property access granted to the service provider in the corresponding timeframe. Sensor data obtained from a sensor associated with the property can be analyzed to determine when an incident related to the property has occurred that needs mediation. An action to remediate the incident is determined and taken, such as to schedule a repair. An automated action can also be taken, e.g., to temporarily halt damage resulting from the issue until the repair can take place. If needed, communication between the party responsible for the property and the service provider is facilitated.

### TECHNICAL FIELD

The subject application relates to property incidents, and related embodiments.

### BACKGROUND

In the event of a need for maintenance or other activity needed at a property, such as a residential or commercial property that requires a maintenance provider to come to the property to service it, it can be difficult and/or time consuming to organize the actions needed to remediate the situation. In many situations this is even more difficult, such as when a homeowner is traveling but some needed service (e.g., fix a sensed water leak) has to be handled quickly.

Regardless of whether time-sensitive or not, when some service such as an appliance repair is needed, there are typically many tasks that need to be coordinated between the property owner (or other person responsible for the property such as a tenant or property manager) and a service provider. This generally includes identifying the problem, describing the problem, scheduling an appointment, and managing access to the property at the scheduled time. Estimates from various service provider candidates are often evaluated as well. Many people are not particularly skilled with respect to handling such tasks.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram of an example system and example representation related to remediation of a property-related issue, in accordance with various aspects and embodiments of the subject disclosure.

FIG. 2 is a block diagram of an example system and example representation related to remediation of a property-related issue upon detection of the issue (incident), in accordance with various aspects and embodiments of the subject disclosure.

FIG. 3 is a block diagram of an example system and example representation related to communicating a property-related issue to begin remediation of the issue, in accordance with various aspects and embodiments of the subject disclosure.

FIG. 4 is a block diagram of an example system and example maintenance data structure containing data related to scheduling of a service provider to resolve an issue, in accordance with various aspects and embodiments of the subject disclosure.

FIG. 5 is a block diagram of an example system and example representation related to communicating between a party responsible for a property and a service provider with respect to an issue needing remediation, in accordance with various aspects and embodiments of the subject disclosure.

FIG. 6 is a block diagram of an example system and example representation related to communicating information to a service provider, including property access with respect to a property issue needing remediation, in accordance with various aspects and embodiments of the subject disclosure.

FIG. 7 is a block diagram of an example system and example representation related to updating a party responsible for a property with respect to status of a property issue needing remediation, in accordance with various aspects and embodiments of the subject disclosure.

FIG. 8 is a block diagram of an example system and example representation related to providing directional property guidance instructions to a service provider, in accordance with various aspects and embodiments of the subject disclosure.

FIG. 9 is a block diagram of an example system and example representation related to messaging between a service provider and party responsible for a property, in accordance with various aspects and embodiments of the subject disclosure.

FIG. 10 is a flow diagram representing example operations related to detecting a property incident and arranging for remediation of the incident, in accordance with various aspects and embodiments of the subject disclosure.

FIG. 11 is a flow diagram representing example operations related to communicating access information to an entity for granting timed access to a property to remediate an incident, in accordance with various aspects and embodiments of the subject disclosure.

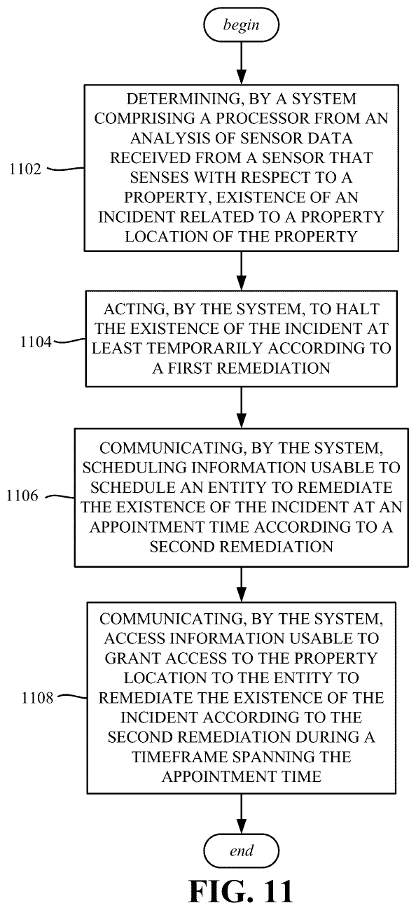

FIG. 12 is a flow diagram representing example operations related to analyzing sensor data to determine an incident related to a property, and determine a remediation action and taking the action, in accordance with various aspects and embodiments of the subject disclosure.

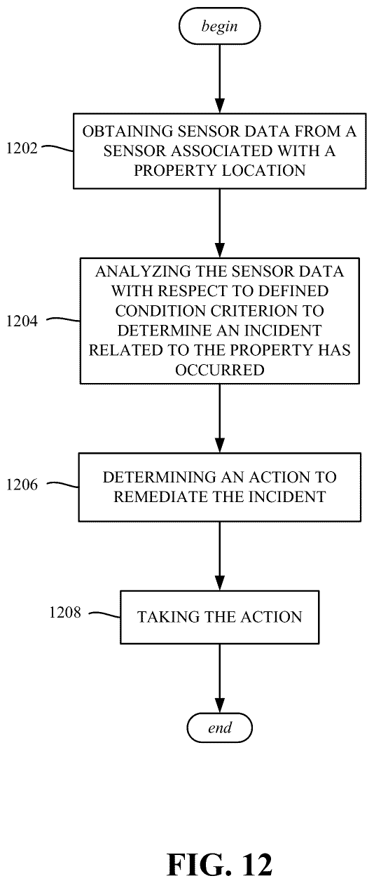

FIG. 13 illustrates an example block diagram of an example mobile handset operable to engage in a system architecture that facilitates wireless communications according to one or more embodiments described herein.

FIG. 14 illustrates an example block diagram of an example computer/machine system operable to engage in a system architecture that facilitates wireless communications according to one or more embodiments described herein.

### DETAILED DESCRIPTION

The technology described herein is generally directed towards enabling a property, such as a residential or commercial property, to act on its own behalf to identify an issue and arrange for mediation of the issue. For example, for a maintenance issue, a property agent device (e.g., a server) to which an issue has been reported can schedule a service provider to resolve the maintenance issue, and manage access property to the service provider at a scheduled time.

Thus, in the event of a need for maintenance or other action at a property that requires an entity to act on the property to remediate the issue, any tasks that need to be coordinated between the party responsible for the property (e.g., property owner, tenant, manager, caretaker) can be done automatically by a property agent device, without requiring interactions from the property owner. If some interaction such as a decision is needed, e.g., a decision on which estimate to accept, the property agent device assists to substantially reduce the need for interaction by the responsible party. Note that while the technology is generally described with examples regarding property maintenance, it is understood that the technology described herein may be applied to other applications as well, such as for the detection of an emergency situation, beckoning an emergency responder, and/or admitting and directing them to the problem, once on site.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth. Olfactory output as well as taste output and/or tactile output can also be part of a promotional presentation as described herein.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

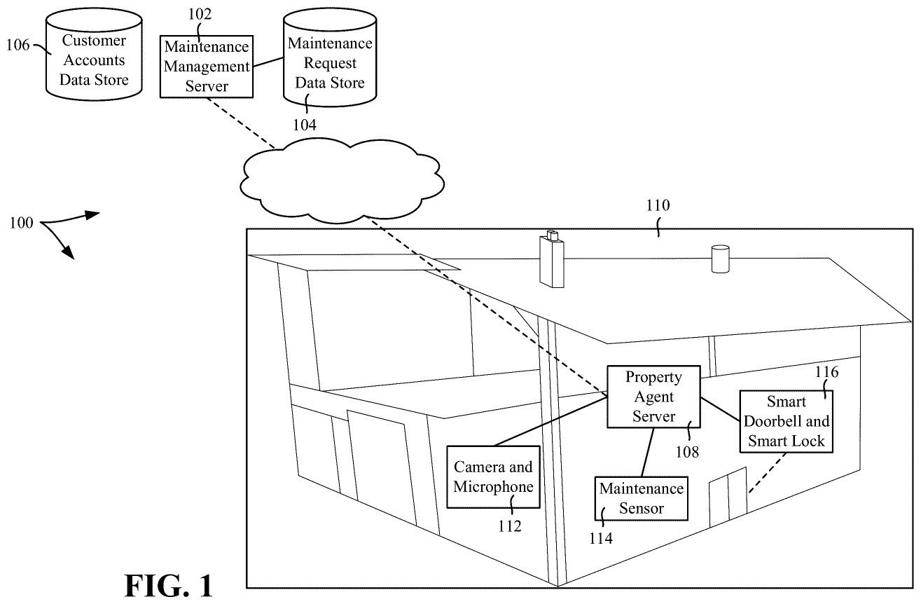

FIG. 1 shows an example system 100 comprising a maintenance management server 102 coupled to a maintenance request data store (e.g., database) 104 and customer accounts data store (e.g., database) 106. In general, the maintenance management server 102 operates by accessing data in the maintenance request data store 104 and/or customer accounts data store 106 to take action with respect to remediating an issue.

As also shown in FIG. 1, a property agent server 108 or the like may exist at or near a property such as a residential building, as depicted in the example representation 110 of a structure. Devices with sensing, access, camera, microphone, and/or other data collection and control capabilities are in communication with the property agent server 108. For example, in FIG. 1, a camera and microphone 112, maintenance sensor 114 (such as a smart water heater), smart doorbell/smart lock (block 116) may be in communication with the property agent server 108 in a given example scenario. As is understood, FIG. 1 shows only one example scenario, and other components in addition to or instead of those shown in FIG. 1 may be present in other scenarios.

The property agent server 108 is in communication with the maintenance management server 108. The maintenance management server 108 may serve more than one property.

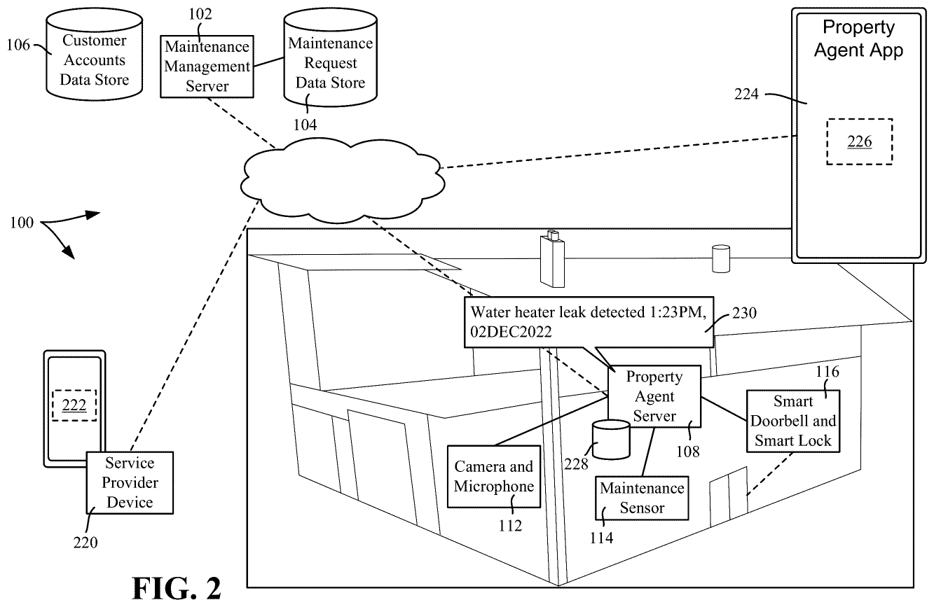

As shown in FIG. 2, a service provider, such as a plumber, is equipped with a communication device 220, such as a smartphone. The service provider's device is equipped with a property service application program (app) 222, which in general operates as an agent/program that includes features appropriate for a service provider.

Likewise, an owner, or other responsible for the property, is equipped with a communication device 224 such as a smartphone, which has a property agent application program (app) 226. In general, the property agent application program 226 operates as an agent/program that includes features appropriate for a person's property in need of service. For purposes of brevity, the person responsible for the property may be referred to herein as the “property owner,” even though that is only one category of a responsible party, and other authorized persons with various roles may be substituted.

A maintenance need may be detected by the property agent server 108 in a number of ways. In one embodiment, the property agent server 108 may maintain a maintenance data store 228 that tracks recurring maintenance tasks and detects that a maintenance task is due to be completed. In another embodiment, the property agent server 108 may receive an alert from one or more maintenance sensors (e.g., the maintenance sensor 114) that an explicit maintenance need exists.

As shown in the example of FIG. 2, this may be, for example, an alert (block 230) from a smart water heater if it detects a leak. Other types of sensors and devices, e.g., smart appliances, may detect a need for service and notify the property agent server 108. Still other types of devices may detect an event and send notice of the event to the property agent server 108 for analysis. For example, image, video, or audio data that is captured (and possibly pre-analyzed for an anomaly) may be sent to the property agent server 108, which may analyze this implicit maintenance need to be a needed maintenance. The property agent server 108 may detect something atypical in the data, such as an overflowing gutter, falling insulation, a puddle, or the like. Manual input may be sent to the maintenance management server 102; for example, a property owner can determine that some non-smart appliance such as a clothes dryer is not functioning correctly, and notify the property agent server 108 to begin handling the issue on his or her behalf thereafter.

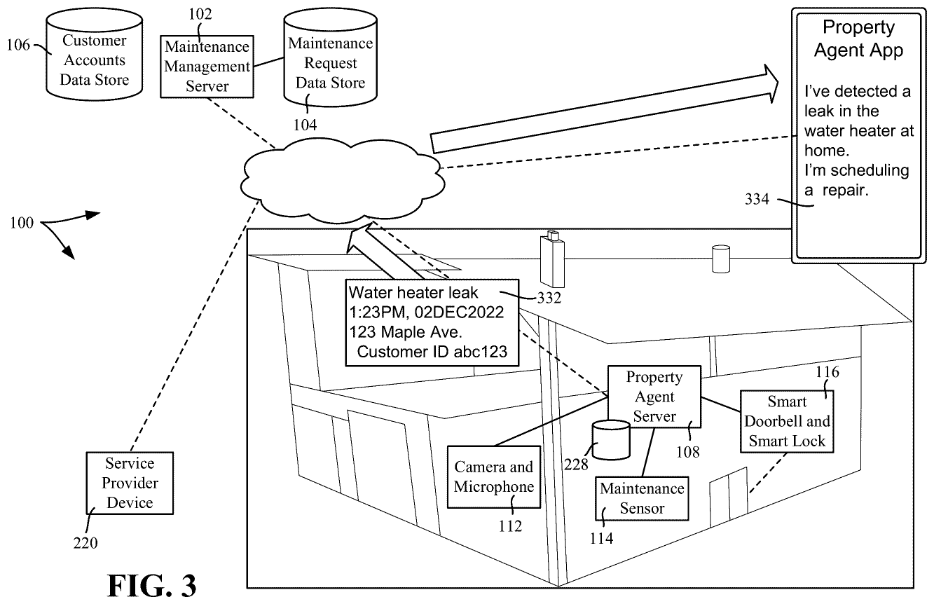

In any event, as shown in FIG. 3, a communication (block 332) associated with a maintenance request may be sent from the property agent server 108 to the maintenance management server 102. The maintenance management server 102 may access the customer accounts data store 106 to determine, based on the nature of the task, which service provider to engage. For example, for a leaky water heater, the maintenance management server 102 looks up the customer's plumber of choice, if one is known. It should be noted that some (or possibly) all of these actions can be done by the property agent server 108, e.g., locally instead of via the maintenance management server 102, but in any event, action is taken to remediate the issue.

Alternatively, the maintenance management server 102 may send the request to one or more other service providers, such as if the property owner does not have a chosen plumber in this example leak incident. As shown in FIG. 3 via the user interface 334 of the property owner's property agent app 226 (FIG. 2), the property agent server 108 also may send an alert to the property owner to alert the owner of the maintenance need.

The property agent server 108 may send similar alert(s) to other approved person(s), such as an adult son of the owner, a trusted neighbor or the like. This can be only temporarily to assist with an issue until a more qualified service provider can fully remediate the issue. For example, if the property owner is traveling and is notified that a water pipe has burst, waiting on the order of hours for a plumber to arrive or for the owner to return to take action may cause serious property damage. Thus, asking a preapproved person to shut off the water may be highly beneficial in mitigating such property damage. A robot may perform such a task in on the premises and properly equipped to handle the task. Similarly, remotely controlling a motorized water shutoff valve can be performed; in this example, the entity that needs to initially act is the shutoff valve, as instructed by the property agent server 108. Note that this alternate alert (or set of alerts) does not require that the property owner respond to the alert sent to him or her, which may not be possible such as if in flight, asleep, in a meeting, or the like.

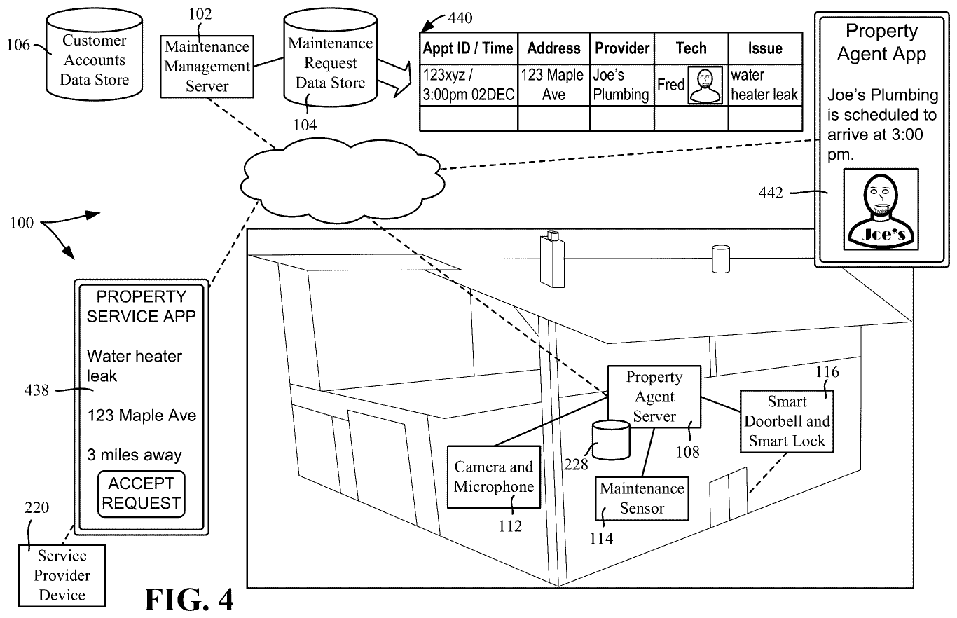

Continuing with the above water leak example, as shown in FIG. 4, the maintenance management server 102 sends a request for service to the one or more identified service providers, where it is received by the service provider device and displayed as an interactive user interface 438 via the property service agent/app (222, FIG. 2). In this example, the request sent to the service provider includes information such as the nature of the request, the urgency of the request (which can be implied from the nature of the request, or can be explicitly noted), and the service location associated with the request. The service provider may accept the request, whether to fulfill it right away or to schedule it for a later time. For example, a furnace cleaning can take place generally any time before autumn, whereas a non-functioning furnace in the winter needs more urgent service.

Once the request is sent to the service provider's device, the maintenance management server 102 may create a connection between the service provider's device and the property agent server 108. This may be for the purpose of establishing a communication to permit the collection of additional information that will aid in the resolution of the issue. For example, the service provider may request the property agent server 108 to send photos, video, or other data about the issue. As a further example, if the service provider asks to send photos or video, the property agent server 108 may communicate with a camera and microphone 112 in the vicinity of the issue to gather real time images. This may be, for instance, to assess the urgency of the issue, such as to see if the water heater leak is causing flooding. This also may be used to help determine a cost estimate, e.g., based on the accessibility to the water heater, particular type of water heater, any special tools or parts likely needed, and/or the like. The property agent server sends the gathered images to the service provider's property agent app 222.

The service provider may optionally negotiate a convenient time with the property agent server 108, which may maintain a schedule for the house or occupants of the house. Upon accepting the request, the service provider provides an estimated time of arrival, generally with additional information, and a maintenance request appointment is established in a maintenance request data store 104.

For example, as shown in FIG. 4, a record 440 (or other suitable data structure) in the maintenance request data store 104 contains elements describing the appointment, and may contain an image of the face of the service provider who will service the appointment. The image may be used for subsequent access to the property, e.g., via facial recognition by the smart doorbell and lock 116 when the service provider arrives. The maintenance management server 102 may send a notice to the property owner's property agent app indicating that an appointment is made, as depicted via the example user interface 442 in FIG. 4.

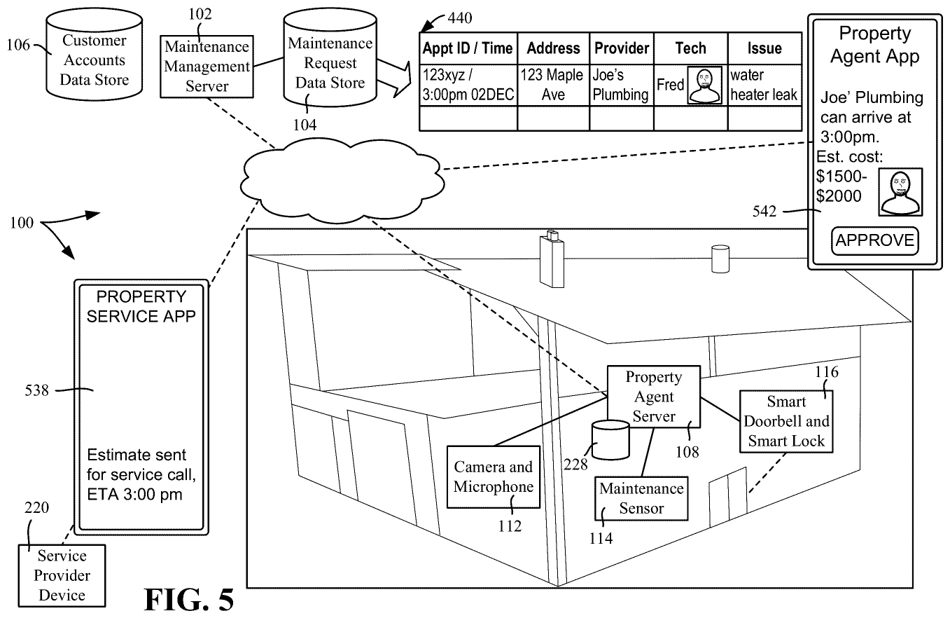

Optionally, the property owner may want to approve the appointment before it is made with the service provider. For example, if the service provider sends an estimate (e.g., as represented by the updated user interface 538 of FIG. 5) the notice that arrives on the property owner's device (interactive user interface 542) may include an “approve” option. The notice may include additional information provided by the service provider to assist the owner in making an approval decision, such as an estimated cost for providing the service. Although not explicitly shown, it is understood that similar proposal (e.g., time and cost estimate) data may be received from one or more different service providers so that the property owner can compare proposals and decide.

Upon the establishment of the appointment, the property agent server 108 may communicate with a smart lock 116 on the property to set a timed key for access to the property. The key may be based on facial recognition, or a key code (such as if facial recognition is not practical because one of many plumbers may be assigned, or there is not a suitable camera). The key code (e.g., barcode, QR code, electronic signal, numeric code, a physical key in a lockbox and so on), allows the service provider access to the property, as well as possibly to lock it up before the expiration time.

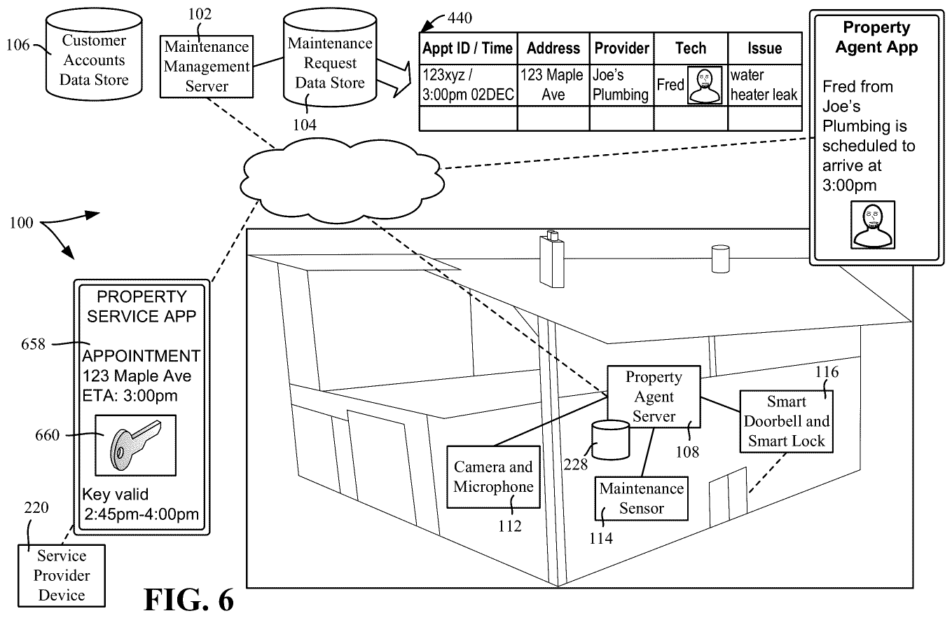

As shown via the user interface 658 of FIG. 6, the key may be valid for only a specific period of time, such as a timeframe based on the expected time of arrival of the service provider. Upon the creation of the key, a digital representation of the key 660 may be sent from the property agent server 108 via the maintenance management server 102 to the service provider's device. The owner's property agent app can provide the owner with updated information, such as represented in the property agent app user interface 664 of FIG. 6.

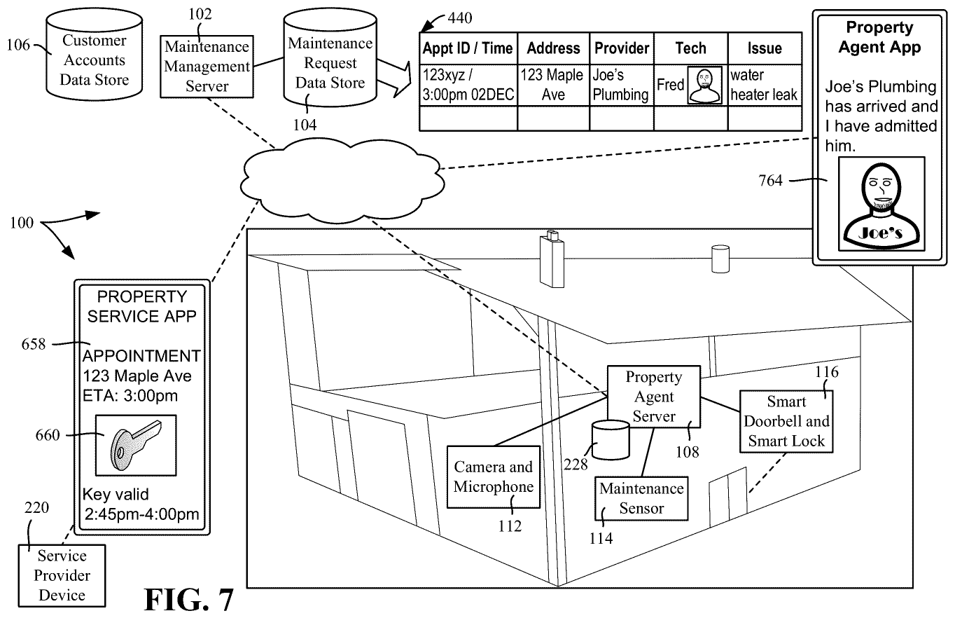

The property agent server 108 may acknowledge access with facial recognition and/or via the timed key. Thus, when the service provider arrives at the property location, he or she may use the key provided to access the smart lock 116. If the image/facial recognition is not used solely as the key, a smart doorbell or camera at the location may be used to obtain an image of the face of the service provider and compare it with the image saved in the maintenance request database for the appointment to further confirm that access is being provided to the technician that was indicated. Similarly, the plumber's company truck and/or a license plate may be recognized in an image. The property agent server 108 sends notification to the property owner's property agent app indicating that the service provider has been admitted upon their arrival, such as represented in the property agent app user interface 764 of FIG. 7.

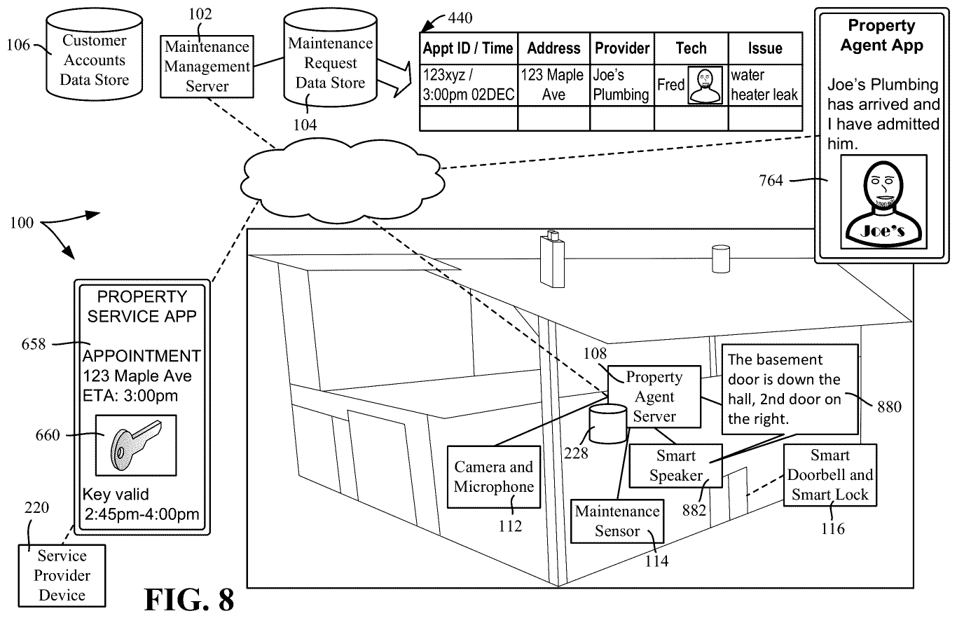

Upon entry at the location, one or more devices such as smart speakers and/or a monitor that are able to communicate with the property agent server 108 may be used by the property agent server 108 to direct the service provider to the location of the issue. This is shown in FIG. 8 via block 880 as output by a smart speaker 882. A camera, motion sensor, or other sensor inside the location may be used to help determine the location of the service provider at the location so as to better provide directions to him or her.

It should be noted that with respect to motion sensing (or other alarm triggering mechanism such as a door sensor), an alarm system coupled to motion sensors can be deactivated for certain motion sensors and not others. For example, consider that a service provider is to go into a house basement to evaluate the water heater leak; the service provider should not go upstairs, nor enter into any areas on the first floor that do not lead to the staircase, (although possibly access to some area such as a restroom may be allowed). Any motion detected that is not along the appropriate path will trigger the alarm system; the service provider can be pre-warned to not go anywhere in the house that is not reasonably along the path.

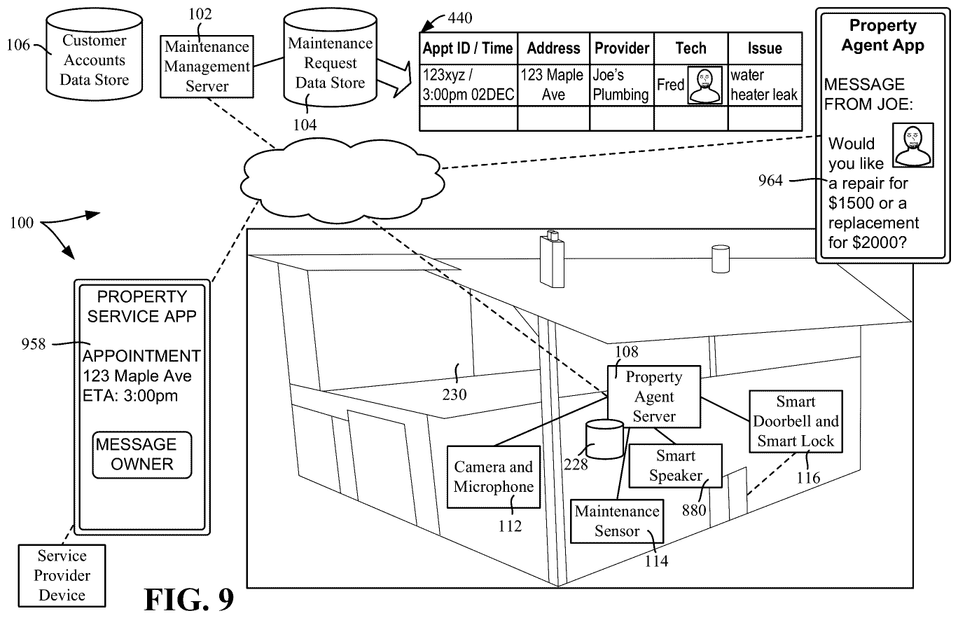

In the course of establishing the maintenance request record 440 in the maintenance request data store 104, the maintained information may include a communication address for the respective agent apps on the property owner's device 224 and the service provider's device 220. Such information may be available to the maintenance management server 102 from one or more other sources, however. As a result, either the service provider or the property owner may use the property service agent/app 222 or property agent app 226, respectively, to initiate a communication with the other party. This may be used, for instance, if the service provider has a question that cannot be satisfied by communications with the property agent server 108. In the example of FIG. 9, the service provider has sent a message to the property owner, as shown via their respective device user interfaces 958 and 964, respectively.

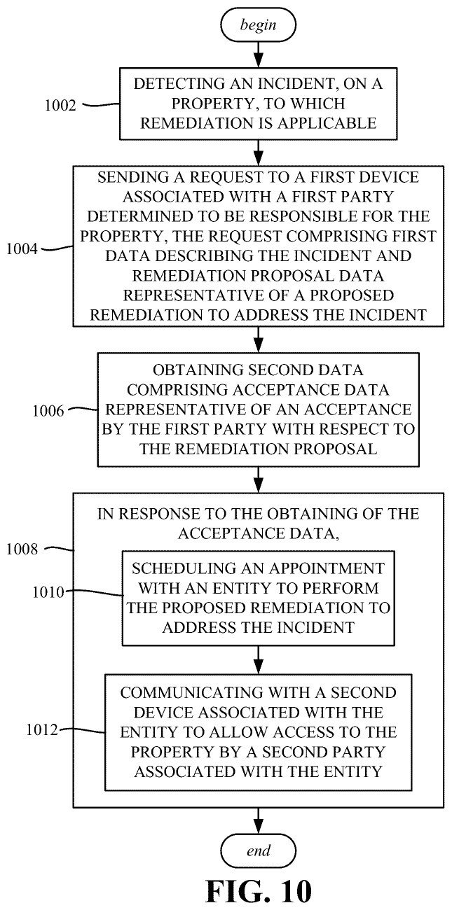

One or more example aspects are represented in FIG. 10, and can correspond to a system, including a processor, and a memory that stores executable instructions that, when executed by the processor, facilitate performance of operations. Example operation 1002 represents detecting an incident, on a property, to which remediation is applicable. Example operation 1004 represents sending a request to a first device associated with a first party determined to be responsible for the property, the request comprising first data describing the incident and remediation proposal data representative of a proposed remediation to address the incident. Example operation 1006 represents obtaining second data comprising acceptance data representative of an acceptance by the first party with respect to the remediation proposal. Example operation 1008 represents, in response to the obtaining of the acceptance data, scheduling an appointment with an entity to perform the proposed remediation to address the incident (Example operation 1010), and communicating with a second device associated with the entity to allow access to the property by a second party associated with the entity (example operation 1012).

Further operations can include communicating, to the second device of the entity, directional guidance data representative of directional guidance to a location of the incident.

Further operations can include, in response to determining that the access to the property has taken place by the second party, sending, via the first device, an alert directed to the first party to inform the first party of the access to the property by the second party.

Further operations can include obtaining sensor data from a sensor proximate to the incident, and sending the sensor data to the second device associated with the entity.

The entity can be a first entity, the remediation proposal data can include a first estimate received based on first user input to the second device from the first entity and a second estimate received based on second user input to a third device associated with a second entity, and obtaining the second data can include obtaining the acceptance data with respect to the acceptance of the first estimate and without any acceptance with respect to the second estimate.

Further operations can include accessing a data store, based on the incident, to determine the entity, and wherein the remediation proposal data identifies the entity.

Communicating with the second device associated with the entity can include sending access code data representative of an access code usable to allow the access to the property.

Communicating with the second device associated with the entity can include receiving an image by which affirmative recognition, matched by a camera at the property at a time based on the appointment, allows the access to the property by the second party.

Communicating with the second device associated with the entity can include sending access code data that is valid during a timeframe defined based on a time associated with the appointment.

Further operations can include deactivating an alarm during a timeframe defined based on a time associated with the appointment.

Further operations can include deactivating a first alarm during a timeframe defined based on a time associated with the appointment, in which the first alarm is on a path to a location of the incident, and leaving a second alarm activated, wherein the second alarm is not on the path to the location of the incident.

The first data can include at least one of: type data specifying a nature of the request, priority data specifying an urgency of the request, or location data associated with a location of the incident.

Further operations can include initiating a communication session, between a first party device of the first party and a second party device of the second party, in conjunction with the appointment.

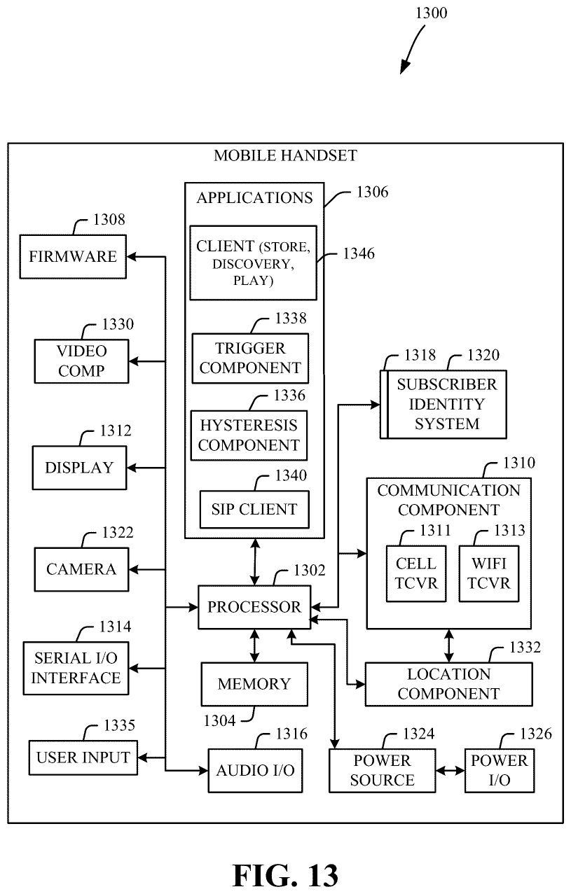

One or more example aspects are represented in FIG. 13, and, for example, can correspond to operations, such as of a method. Example operation 1302 represents determining, by a system comprising a processor from an analysis of sensor data received from a sensor that senses with respect to a property, existence of an incident related to a property location of the property. Example operation 1302 represents acting, by the system, to halt the existence of the incident at least temporarily according to a first remediation. Example operation 1302 represents communicating, by the system, scheduling information usable to schedule an entity to remediate the existence of the incident at an appointment time according to a second remediation. Example operation 1302 represents communicating, by the system, access information usable to grant access to the property location to the entity to remediate the existence of the incident according to the second remediation during a timeframe spanning the appointment time.

Acting to halt the incident can include sending a notification to a device of a party to take a manual action to halt the existence of the incident.

Acting to halt the incident comprises communicating with a device to take an automated action to halt the existence of the incident.

Further operations can include operating, by the system, to grant the access to an identified party associated with the entity.

Communicating the scheduling information usable to schedule the entity to remediate the incident comprises obtaining authorization from an owning party determined to own the property or a property manager determined to be responsible for the property.

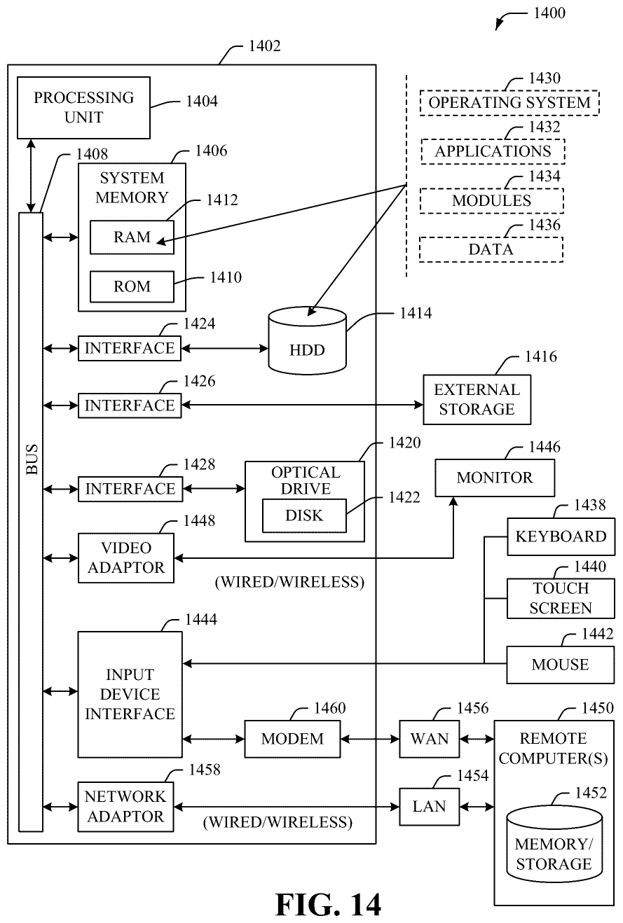

One or more aspects are represented in FIG. 14, such as implemented in a machine-readable medium, including executable instructions that, when executed by a processor, facilitate performance of operations. Example operation 1402 represents obtaining sensor data from a sensor associated with a property location. Example operation 1404 represents analyzing the sensor data with respect to defined condition criterion to determine an incident related to the property has occurred. Example operation 1406 represents determining an action to remediate the incident. Example operation 1408 represents taking the action.

Analyzing the sensor data can include processing the sensor data to detect at least one of: atypical image data, atypical video data, or atypical audio data respectively relative to defined baseline image data, defined baseline video data, or defined baseline audio data.

As can be seen, the technology described herein handles and/or assists with the tasks that need to be coordinated between a party responsible for a property and a service provider or other entity from which action is needed. This includes automatically performing (or at least helping with) identifying the problem, describing the problem, scheduling an appointment, and managing access to the property at the scheduled appointment time. These tasks are managed by a property agent program or the like, generally without requiring interactions from the party responsible for a property, or if some interaction is needed, with significantly reduced interaction by the responsible party.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

Referring now to FIG. 13, illustrated is a schematic block diagram of an example end-user device (such as user equipment) that can be a mobile device 1300 capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 810, includes an indoor network radio transceiver 1313 (e.g., Wi-Fi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
detecting an incident, on a property, to which remediation is applicable;
sending a request to a first device associated with a first party determined to be responsible for the property, the request comprising first data describing the incident and remediation proposal data representative of a proposed remediation to address the incident;
obtaining second data comprising acceptance data representative of an acceptance by the first party with respect to the remediation proposal; and
in response to the obtaining of the acceptance data,
scheduling an appointment with an entity to perform the proposed remediation to address the incident, and
communicating with a second device associated with the entity to allow access to the property by a second party associated with the entity.

2. The system of claim 1, wherein the operations further comprise communicating, to the second device of the entity, directional guidance data representative of directional guidance to a location of the incident.

3. The system of claim 1, wherein the operations further comprise, in response to determining that the access to the property has taken place by the second party, sending, via the first device, an alert directed to the first party to inform the first party of the access to the property by the second party.

4. The system of claim 1, wherein the operations further comprise obtaining sensor data from a sensor proximate to the incident, and sending the sensor data to the second device associated with the entity.

5. The system of claim 1, wherein the entity is a first entity, wherein the remediation proposal data comprises a first estimate received based on first user input to the second device from the first entity and a second estimate received based on second user input to a third device associated with a second entity, and wherein the obtaining of the second data comprises obtaining the acceptance data with respect to the acceptance of the first estimate and without any acceptance with respect to the second estimate.

6. The system of claim 1, wherein the operations further comprise accessing a data store, based on the incident, to determine the entity, and wherein the remediation proposal data identifies the entity.

7. The system of claim 1, wherein the communicating with the second device associated with the entity comprises sending access code data representative of an access code usable to allow the access to the property.

8. The system of claim 1, wherein the communicating with the second device associated with the entity comprises receiving an image by which affirmative recognition, matched by a camera at the property at a time based on the appointment, allows the access to the property by the second party.

9. The system of claim 1, wherein the communicating with the second device associated with the entity comprises sending access code data that is valid during a timeframe defined based on a time associated with the appointment.

10. The system of claim 1, wherein the operations further comprise deactivating an alarm during a timeframe defined based on a time associated with the appointment.

11. The system of claim 1, wherein the operations further comprise:
deactivating a first alarm during a timeframe defined based on a time associated with the appointment, wherein the first alarm is on a path to a location of the incident; and
leaving a second alarm activated, wherein the second alarm is not on the path to the location of the incident.

12. The system of claim 1, wherein the first data comprises at least one of: type data specifying a nature of the request, priority data specifying an urgency of the request, or location data associated with a location of the incident.

13. The system of claim 1, wherein the operations further comprise initiating a communication session, between a first party device of the first party and a second party device of the second party, in conjunction with the appointment.

14. A method, comprising:
determining, by a system comprising a processor from an analysis of sensor data received from a sensor that senses with respect to a property, existence of an incident related to a property location of the property;
acting, by the system, to halt the existence of the incident at least temporarily according to a first remediation;
communicating, by the system, scheduling information usable to schedule an entity to remediate the existence of the incident at an appointment time according to a second remediation; and
communicating, by the system, access information usable to grant access to the property location to the entity to remediate the existence of the incident according to the second remediation during a timeframe spanning the appointment time.

15. The method of claim 14, wherein the acting to halt the incident comprises sending a notification to a device of a party to take a manual action to halt the existence of the incident.

16. The method of claim 14, wherein the acting to halt the incident comprises communicating with a device to take an automated action to halt the existence of the incident.

17. The method of claim 14, further comprising operating, by the system, to grant the access to an identified party associated with the entity.

18. The method of claim 14, wherein the communicating of the scheduling information usable to schedule the entity to remediate the incident comprises obtaining authorization from an owning party determined to own the property or a property manager determined to be responsible for the property.

19. A non-transitory machine-readable medium, comprising executable instructions that, when executed by a processor, facilitate performance of operations, the operations comprising:
obtaining sensor data from a sensor associated with a property location;
analyzing the sensor data with respect to defined condition criterion to determine an incident related to the property has occurred;
determining an action to remediate the incident; and
taking the action.

20. The non-transitory machine-readable medium of claim 19, wherein the analyzing of the sensor data comprises processing the sensor data to detect at least one of: atypical image data, atypical video data, or atypical audio data respectively relative to defined baseline image data, defined baseline video data, or defined baseline audio data.
